(19) United States
(12) Patent Application Publication
(10) Pub. No.: US 2021/0406622 A1
(43) Pub. Date: Dec. 30, 2021

(54) PRINTER, METHOD OF CONTROLLING PRINTER, AND NON-TRANSITORY COMPUTER-READABLE STORAGE MEDIUM STORING PROGRAM

(71) Applicant: SEIKO EPSON CORPORATION, Tokyo (JP)

(72) Inventor: Satoshi MORIYAMA, Matsumoto-shi (JP)

(21) Appl. No.: 17/304,497

(22) Filed: Jun. 22, 2021

(30) Foreign Application Priority Data
Jun. 25, 2020 (JP) 2020-109419

(51) Int. Cl. G06K 15/10; G06K 15/00; G06K 15/02; B41J 2/045

(52) U.S. Cl. CPC G06K 15/105; G06K 15/408; B41J 2/04586; B41J 2/04556; G06K 15/1809

(57) ABSTRACT

A printer configured to perform printing on a medium while being manually moved to the medium includes a print job acquisition section configured to obtain a print job, a movement detection section configured to detect a movement direction of the printer relative to the medium, and a first control section configured to make a print head while the printer is moved in a first direction in an odd-numbered pass, and make the print head perform printing while the printer is moved in an opposite direction to the first direction in an even-numbered pass. When the printer is moved in the opposite direction to the movement direction in the pass in which the printing is in progress other than the last pass, the first control section stops the printing by the print head in the pass in which the printing is in progress and the subsequent passes.

The present application is based on, and claims priority from JP Application Serial Number 2020-109419, filed Jun. 25, 2020, the disclosure of which is hereby incorporated by reference herein in its entirety.

### BACKGROUND

### 1. Technical Field

The present disclosure relates to a printer, a method of controlling a printer, and a non-transitory computer-readable storage medium storing a program.

### 2. Related Art

In the past, as disclosed in JP-A-2018-144338 (Document 1), there has been known a handy mobile printer which performs printing on a medium while being manually moved to the medium. As shown in FIG. 19, the handy mobile printer of this kind is capable of performing bidirectional printing which is achieved by repeating an operation of performing printing of a print image PA1 in a first pass while being moved in a +X direction, then being moved in a −Y direction after completion of the printing of the print image PA1 in the first pass, and then performing printing of a print image PA2 in a second pass while being moved in a −X direction.

When the handy mobile printer disclosed in Document 1 is moved in the −Y direction, and is then moved in the −X direction, the handy mobile printer performs the printing of the print image PA2 in the second pass even in the middle of the printing of the print image PA1 in the first pass as shown in FIG. 20. In other words, even when the related-art handy mobile printer has not yet printed a posterior half area PA1′ of the print image PA1 in the first pass, the related-art handy mobile printer omits printing of an anterior half area PA2′ of the print image PA2 in the second pass, and starts printing in the middle of the print image PA2 in the second pass. As described above, when the related-art handy mobile printer is moved in an opposite direction to the movement direction of the printer in the printing pass in progress in the middle of the printing of the print image, an incomplete print image is printed as a result, and thus, consumables related to printing are wasted.

### SUMMARY

A printer according to the present disclosure is a printer configured to perform printing on a medium while being manually moved to the medium including a print job acquisition section configured to obtain a print job for printing a print image in a plurality of passes, a movement detection section configured to detect a movement direction of the printer relative to the medium, and a control section configured to make a print head perform printing while the printer is moved in a first direction in an odd-numbered pass, and make the print head perform printing while the printer is moved in an opposite direction to the first direction in an even-numbered pass based on the print job, wherein when the printer is moved in an opposite direction to the movement direction of the printer in a pass in which the printing is in progress in a middle of the printing in the pass other than a last pass out of the plurality of passes, the control section performs a printing stop process of stopping the printing by the print head in the pass in which the printing is in progress and subsequent passes.

A method of controlling a printer according to the present disclosure is a method of controlling the printer configured to perform printing on a medium while being manually moved to the medium, the method executing a print job acquisition step of obtaining a print job for printing a print image in a plurality of passes, a movement detection step of detecting a movement direction of the printer relative to the medium, and a control step of making a print head perform printing while the printer is moved in a first direction in an odd-numbered pass, and making the print head perform printing while the printer is moved in an opposite direction to the first direction in an even-numbered pass based on the print job obtained, wherein in the control step, when the printer is moved in an opposite direction to the movement direction of the printer in a pass in which the printing is in progress in a middle of the printing in the pass other than a last pass out of the plurality of passes, the printing by the print head in the pass in which the printing is in progress and subsequent passes is stopped.

A non-transitory computer-readable storage medium storing a program according to the present disclosure stores a program that makes an information processing device coupled to a printer configured to perform printing on a medium while being manually moved to the medium so as to communicate with each other execute processing including a print job generation step of generating a print job for making the printer print a print image in a plurality of passes, a monitoring step of monitoring a movement direction of the printer relative to the medium, and a control step of making the printer perform printing while the printer is moved in a first direction in an odd-numbered pass, and making the printer perform printing while the printer is moved in an opposite direction to the first direction in an even-numbered pass based on the print job, wherein in the control step, when the printer is moved in an opposite direction to the movement direction of the printer in a pass in which the printing is in progress in a middle of the printing in the pass other than a last pass out of the plurality of passes, the printing by the printer in the pass in which the printing is in progress and subsequent passes is stopped.

### BRIEF DESCRIPTION OF THE DRAWINGS

FIG. 1 is a system configuration diagram of a printing system.

FIG. 2 is an exterior perspective view of a printer.

FIG. 3 is an exterior perspective view of the printer viewed from another angle than in FIG. 2.

FIG. 4 is a diagram showing a state in which the printer is moved in a +X direction.

FIG. 5 is an explanatory diagram of unidirectional printing.

FIG. 6 is an explanatory diagram of bidirectional printing.

FIG. 7 is a control block diagram of a printing system according to a first embodiment.

FIG. 8 is a diagram showing a print instruction screen.

FIG. 9 is a diagram showing a print configuration screen.

FIG. 10 is a functional block diagram of a printer according to the first embodiment.

FIG. 11 is a diagram showing a state in which printing of a print image is stopped.

FIG. 12 is a flowchart showing a flow of processing of the printing system according to the first embodiment.

FIG. 13 is a flowchart following the flowchart shown in FIG. 12.

FIG. 14 is a diagram of a printer provided with a display viewed from a +Z direction.

FIG. 15 is a diagram showing an error screen.

FIG. 16 is a control block diagram of a printing system according to a second embodiment.

FIG. 17 is a functional block diagram of an information processing device according to the second embodiment.

FIG. 18 is a flowchart showing a flow of processing of the information processing device according to the second embodiment.

FIG. 19 is an explanatory diagram when printing a complete print image by a related-art handy mobile printer.

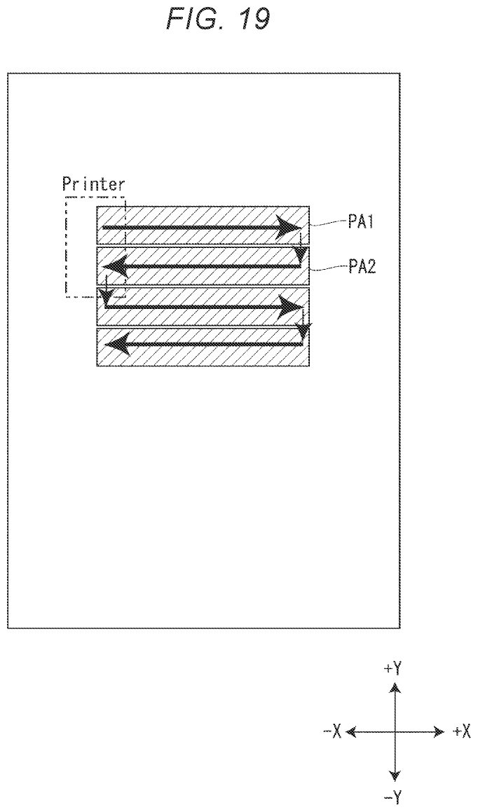

FIG. 20 is an explanatory diagram when printing an incomplete print image by the related-art handy mobile printer.

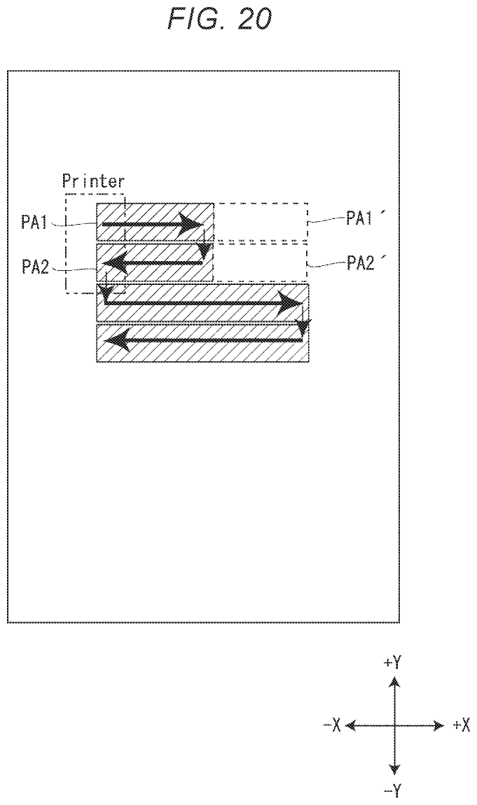

### DESCRIPTION OF EXEMPLARY EMBODIMENTS

Hereinafter, some embodiments of a printer, a method of controlling a printer, and a non-transitory computer-readable storage medium storing a program will be described with reference to the accompanying drawings.

### First Embodiment

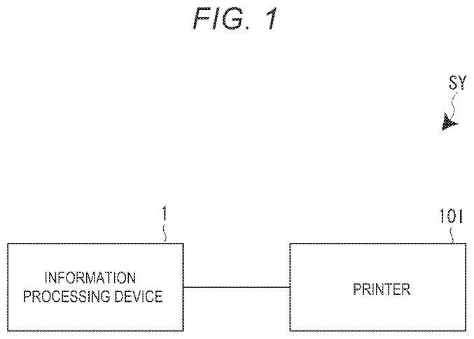

FIG. 1 is a system configuration diagram of a printing system SY. The printing system SY is provided with an information processing device 1 and a printer 101. The information processing device 1 and the printer 101 are coupled to each other so as to be able to communicate with each other wirelessly or with wire.

The information processing device 1 transmits a print job to the printer 101. As the information processing device 1, there can be used, for example, a smartphone, a tablet terminal, or a personal computer.

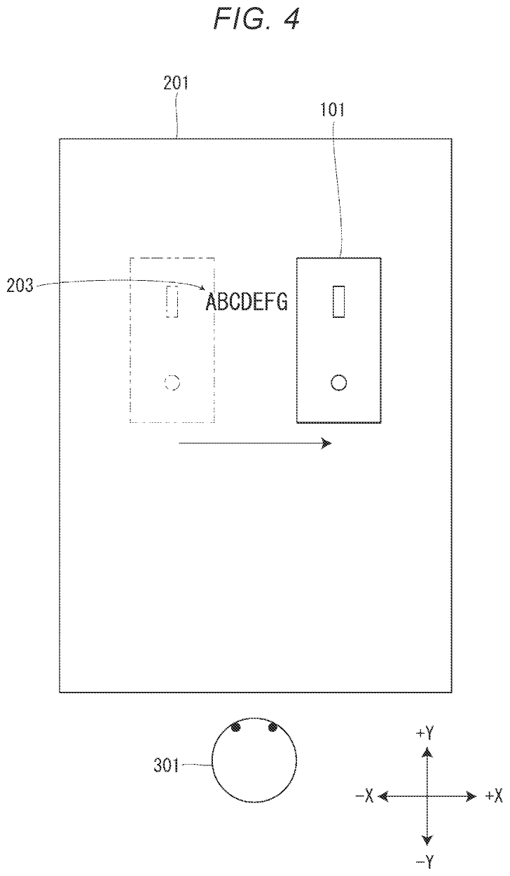

The printer 101 performs printing on a medium 201 (see FIG. 4) based on the print job received from the information processing device 1. The printer 101 is a so-called handy printer, and performs printing while being manually moved to the medium 201. It should be noted that the medium 201 is not limited to printing paper, but there can be used, for example, an envelope, a postcard, a business card, cardboard, a notebook, and a CD (Compact Disc).

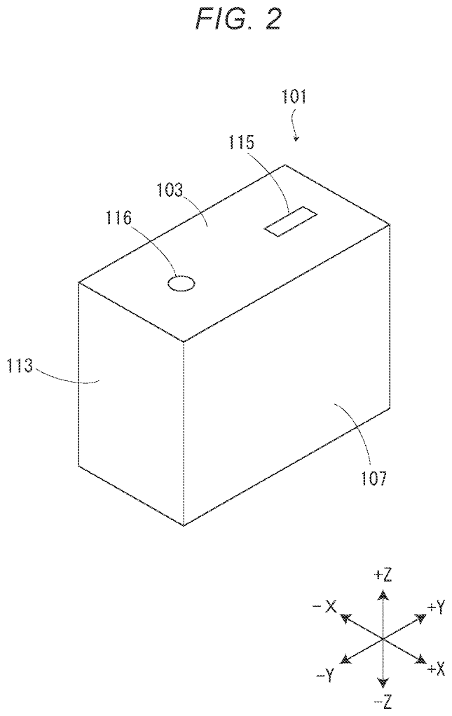

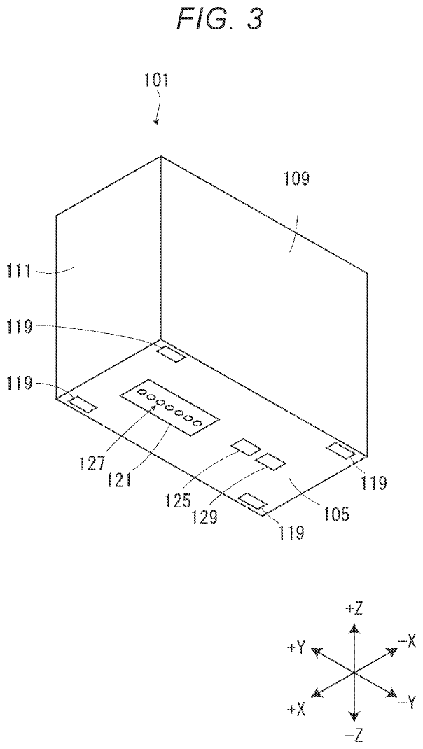

An exterior configuration of the printer 101 will be described based on FIG. 2 and FIG. 3. It should be noted that directions viewed from the printer 101 will hereinafter be described using directions defined by an XYZ Cartesian coordinate system shown in each of the drawings, but these directions are for the sake of convenience of explanation only, and do not at all limit the following embodiments.

The printer 101 is formed to have a substantially rectangular solid shape. Out of six outer surfaces of the printer 101, an outer surface on which a print button 115 described later is disposed is referred to as a first outer surface 103, and an outer surface at an opposite side to the first outer surface 103 is referred to as a second outer surface 105. Further, out of four outer surfaces corresponding to side surfaces assuming that the first outer surface 103 or the second outer surface 105 is a bottom surface, one of two outer surfaces large in area is referred to as a third outer surface 107, and the other thereof is referred to as a fourth outer surface 109. Further, out of the four outer surfaces corresponding to the side surfaces, one of two outer surfaces small in area is referred to as a fifth outer surface 111, and the other thereof is referred to as a sixth outer surface 113. In other words, the first outer surface 103, the second outer surface 105, the third outer surface 107, the fourth outer surface 109, the fifth outer surface 111, and the sixth outer surface 113 are disposed at the +Z direction side, the −Z direction side, the +X direction side, the −X direction side, the +Y direction side, and the −Y direction side, respectively, when viewed from the printer 101.

On the first outer surface 103 of the printer 101, there are disposed the print button 115 and a power button 116. The print button 115 receives a printing start instruction from a user 301 (see FIG. 4). The printing start instruction from the user 301 is performed by, for example, a short press of the print button 115. The print button 115 is disposed so as to be shifted toward the +Y direction from a central portion of the first outer surface 103. It is possible for the user 301 to make the printer 101 print a print image 203 (see FIG. 4) by putting the printer 101 on the medium 201, then making a short press of the print button 115, and then gripping the printer 101 to move the printer 101 freehand along a surface of the medium 201.

Further, the print button 115 receives a printing termination instruction from the user 301. The printing termination instruction from the user 301 is performed by, for example, a long press of the print button 115.

Further, the print button 115 incorporates an LED (Light Emitting Diode). The printer 101 blinks the LED incorporated in the print button 115 to thereby give notice of an error. The print button 115 is an example of a “notification section.”

The power button 116 receives a switching instruction between ON and OFF of the power from the user 301. The power button 116 is disposed so as to be shifted toward the −Y direction from the central portion of the first outer surface 103.

As shown in FIG. 3, on the second outer surface 105 of the printer 101, there are disposed a plurality of rollers 119, a print head 121, a movement detection sensor 125, and a distance detection sensor 129.

The plurality of rollers 119 has frictional contact with the medium 201 and rotates to thereby guide the movement of the printer 101 in the X direction relative to the medium 201.

The print head 121 is an inkjet head provided with a nozzle array 127 having a plurality of nozzles arranged, and ejects ink from the nozzles to thereby print the print image 203 on the medium 201. The print head 121 is disposed so as to be shifted toward the +Y direction from a central portion of the second outer surface 105. In other words, the print head 121 is disposed at the −Z direction side of the print button 115 described above. The nozzle array 127 is disposed in the Y direction.

The movement detection sensor 125 optically reads fine asperity of the medium 201 to thereby output a movement detection signal while the printer 101 is moved to the medium 201. The printer 101, based on the movement detection signal output from the movement detection sensor 125, detects amounts of the movement in the X direction and the Y direction, and a movement direction in the X direction and the Y direction. The movement detection sensor 125 is disposed at the −Y direction side with respect to the print head 121.

The distance detection sensor 129 measures the distance between the printer 101 and the medium 201 to thereby output a distance detection signal. The printer 101 detects a distance from the medium 201 based on the distance detection signal output from the distance detection sensor 129. The distance detection sensor 129 is disposed at the −Y direction side with respect to the movement detection sensor 125.

As shown in FIG. 4, the printer 101 is capable of printing the print image 203 on the medium 201 while being moved in the +X direction to the medium 201. Further, the printer 101 is also capable of printing the print image 203 on the medium 201 while being moved in the −X direction relatively to the medium 201.

Further, when the printer 101 is not capable of executing one print job in a single pass, it is possible for the printer 101 to divide the print job into a plurality of passes to separately execute the passes. Here, the pass means a printing operation performed while the printer 101 is moved in the +X direction or the −X direction. When executing one print job divided into the plurality of passes as described above, it is possible for the user 301 to select either one of the unidirectional printing and the bidirectional printing as the printing direction in the information processing device 1.

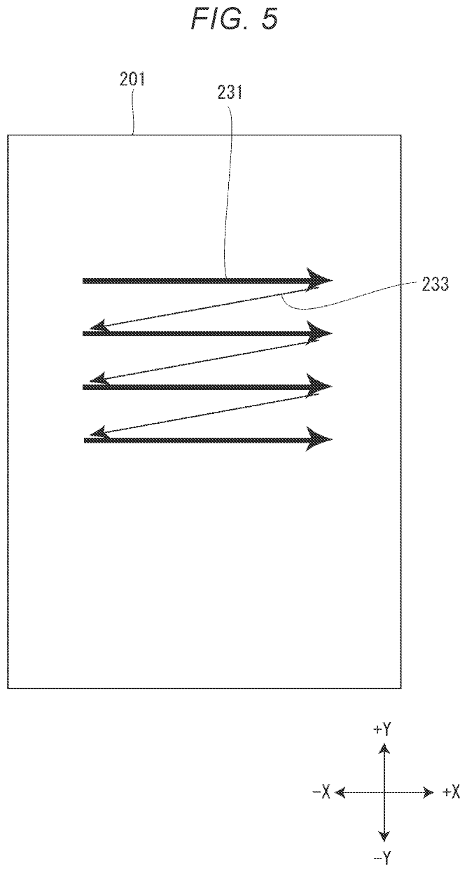

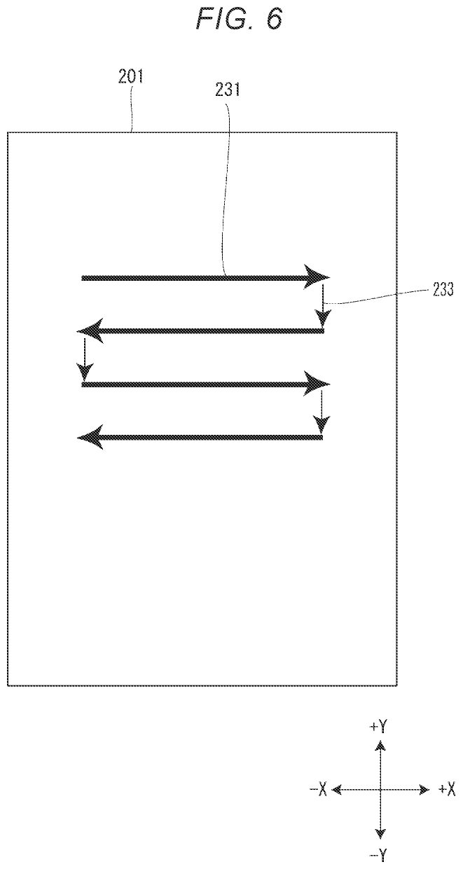

FIG. 5 is a diagram showing a movement path of the printer 101 when the unidirectional printing is selected. Further, FIG. 6 is a diagram showing a movement path of the printer 101 when the bidirectional printing is selected. In both of the drawings, the thick lines each represent a printing movement path 231 as the movement path of the printer 101 when performing printing, and the thin lines each represent a linefeed movement path 233 as the movement path of the printer 101 when performing linefeed. Here, the “linefeed” means a movement of the printer 101 not accompanied by printing from a movement ending position of a pass of the printer 101 to a movement starting position of the next pass.

As shown in FIG. 5, when the unidirectional printing is selected, the printer 101 repeats an operation of performing printing corresponding to one pass while moving toward the +X direction, and then performing linefeed toward the −X direction and the −Y direction. It should be noted that the linefeed toward the −X direction and the −Y direction can be achieved by being moved in an oblique direction between the −X direction and the −Y direction, being moved toward the −X direction and then moved toward the −Y direction, or being moved toward the −Y direction and then moved toward the −X direction.

On the other hand, as shown in FIG. 6, when the bidirectional printing is selected, the printer 101 repeats an operation of performing printing corresponding to one pass while moving toward the +X direction, then performing linefeed toward the −Y direction, then performing printing in the next pass while moving toward the −X direction, and then performing linefeed toward the −Y direction. In other words, when the bidirectional printing is selected, the printer 101 performs printing while moving toward the +X direction in the odd-numbered passes, and performs printing while moving toward the −X direction in the even-numbered passes.

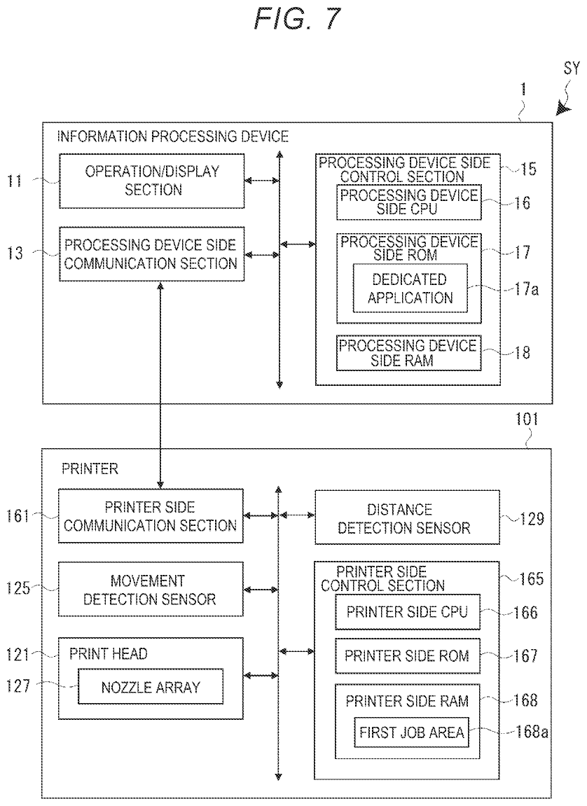

A hardware configuration of the printing system SY will be described with reference to FIG. 7. The printing system SY is provided with the information processing device 1 and the printer 101. The information processing device 1 is provided with an operation/display section 11, a processing device side communication section 13, and a processing device side control section 15.

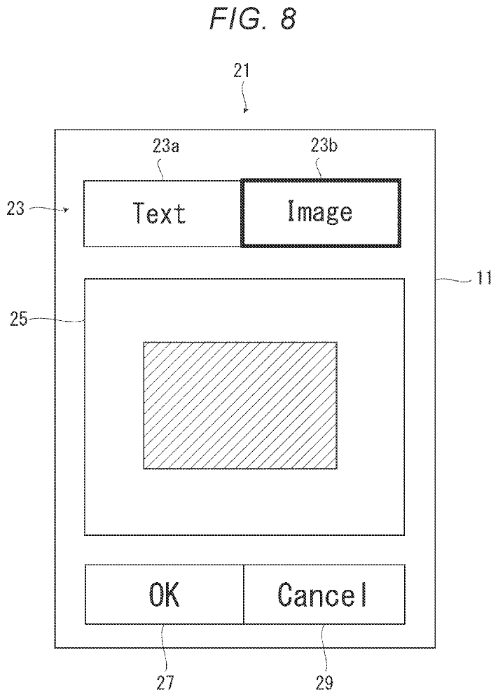

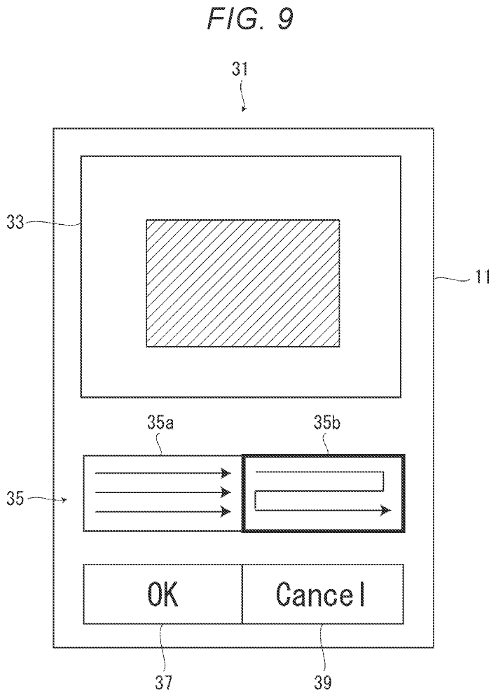

The operation/display section 11 is, for example, a touch panel, and is used for a variety of operations by the user 301 and display of a variety of types of information. The operation/display section 11 displays, for example, a print instruction screen 21 (see FIG. 8) and a print configuration screen 31 (see FIG. 9).

Here, the print instruction screen 21 and the print configuration screen 31 will be described. As shown in FIG. 8, in the print instruction screen 21, there are disposed a print type selection field 23, an information input field 25, a first OK button 27, and a first cancel button 29.

In the print type selection field 23, a text alternative 23a and an image alternative 23b are displayed in a selectable manner. When the text alternative 23a is selected in the print type selection field 23, a text is input in the information input field 25. It should be noted that the text means information attached with a text code such as a character, a number, a symbol, or a pictogram input from a software keyboard not shown. Further, when the image alternative 23b is selected in the print type selection field 23, an image is drawn or inserted in the information input field 25. It should be noted that the image means information not attached with a text code.

When the text alternative 23a is selected in the print type selection field 23, the text input is displayed in the information input field 25. Further, when the image alternative 23b is selected in the print type selection field 23, the image drawn or inserted is displayed in the information input field 25. The print instruction screen 21 in this diagram shows a case where the image alternative 23b is selected in the print type selection field 23, and the image is displayed in the information input field 25.

The first OK button 27 receives an operation for fixing the information input in the print instruction screen 21. When the information processing device 1 receives an operation of the first OK button 27, the information processing device 1 fixes the information input to display the print configuration screen 31. The first cancel button 29 receives an operation for canceling the information input in the print instruction screen 21. When the information processing device 1 receives an operation of the first cancel button 29, the information processing device 1 resets the information input to the print instruction screen 21 to display an initial screen not shown.

As shown in FIG. 9, in the print configuration screen 31, there are disposed a print preview 33, a printing direction selection field 35, a second OK button 37, and a second cancel button 39.

In the print preview 33, there is displayed a preview of the print image 203 based on information input to the information input field 25 in the print instruction screen 21. As shown in FIG. 8, when the image alternative 23b is selected in the print type selection field 23 in the print instruction screen 21, the information processing device 1 displays the preview of the print image 203 based on the image drawn or inserted in the information input field 25 in the print instruction screen 21 as the print preview 33.

When the text alternative 23a is selected in the print type selection field 23 in the print instruction screen 21, a unidirectional printing alternative 35a and a bidirectional printing alternative 35b are displayed in the printing direction selection field 35 in a selectable manner. It should be noted that when the print image 203 can be executed in a single pass, it is possible for the information processing device 1 to make only the unidirectional printing alternative 35a selectable, and to make the bidirectional printing alternative 35b unselectable.

Further, when the image alternative 23b is selected in the print type selection field 23 in the print instruction screen 21, only the bidirectional printing alternative 35b is made selectable, and the unidirectional printing alternative 35a is made unselectable in the printing direction selection field 35. In other words, when the printer 101 prints the print image 203 as the image, the printer 101 performs the bidirectional printing.

It should be noted that when the image alternative 23b is selected in the print type selection field 23 in the print instruction screen 21, it is possible for the information processing device 1 to make it possible to set the length in the X direction and the length in the Y direction of the image in the print configuration screen 31.

The second OK button 37 receives an operation for fixing the selection in the print configuration screen 31. When the information processing device 1 receives an operation of the second OK button 37, the information processing device 1 generates print data, and transmits the print job including the print data thus generated and information representing the print type to the printer 101. It should be noted that when the print type is the “text,” the information processing device 1 includes information representing the printing direction in the print job, and then transmits the print job to the printer 101. The second cancel button 39 receives an operation for canceling the selection in the print configuration screen 31. When the information processing device 1 receives an operation of the second cancel button 39, the information processing device 1 resets the settings of the print configuration screen 31 to display the print instruction screen 21.

Going back to the description of FIG. 7, the processing device side communication section 13 wirelessly communicates with the printer 101. For example, the processing device side communication section 13 transmits the print job to the printer 101.

The processing device side control section 15 includes a processing device side CPU (Central Processing Unit) 16, a processing device side ROM (Read Only Memory) 17, and a processing device side RAM (Random Access Memory) 18.

The processing device side CPU 16 develops a variety of control programs stored in the processing device side ROM 17 in the processing device side RAM 18, and then executes the variety of control programs to thereby perform a variety of types of control. It should be noted that it is possible for the processing device side control section 15 to use a hardware circuit such as an ASIC (Application Specific Integrated Circuit) as a processor instead of the processing device side CPU 16. Further, the processor can be provided with a configuration in which one or more CPUs and a hardware circuit such as an ASIC operate in cooperation with each other.

The processing device side ROM 17 is a rewritable ROM such as a flash memory, and stores a variety of control programs and a variety of types of control data. The processing device side RAM 18 is used as a work area for the processing device side CPU 16 to perform a variety of types of control.

The processing device side ROM 17 stores a dedicated application 17a for controlling the printer 101. The processing device side CPU 16 displays the print instruction screen 21 and the print configuration screen 31 using the dedicated application 17a.

Further, the processing device side CPU 16 generates the print job using the dedicated application 17a. More specifically, the processing device side CPU 16 generates the print job based on the information input in the print instruction screen 21 and the settings of the print configuration screen 31.

The printer 101 is provided with a printer side communication section 161, a movement detection sensor 125, the print head 121, the distance detection sensor 129, and a printer side control section 165.

The printer side communication section 161 wirelessly communicates with the information processing device 1.

The movement detection sensor 125 optically reads the fine asperity of the medium 201 to thereby output the movement detection signal for detecting the amount of the movement and the movement direction of the printer 101 while the printer 101 is moved to the medium 201. The movement detection sensor 125 includes, for example, a light source for irradiating the medium 201 with LED (Light Emitting Diode) light, and a light-receiving sensor which receives reflected light from medium 201 of the LED light to output the movement detection signal.

The print head 121 has the nozzle array 127 having the plurality of nozzles arranged. The print head 121 ejects the ink from the plurality of nozzles to thereby perform printing on the medium 201. It should be noted that the print head 121 can be provided with a configuration having a plurality of nozzle arrays 127. Further, it is possible for the printer 101 to have a configuration provided with a plurality of print heads 121. In this case, the plurality of print heads 121 has a configuration in which the ink ejected from the nozzles provided to the print head 121 is different in color between the print heads 121.

The distance detection sensor 129 measures the distance between the printer 101 and the medium 201 to output the distance detection signal as the measurement result. The distance detection sensor 129 includes, for example, a light source for irradiating the medium 201 with infrared light, and a light-receiving sensor which receives the infrared light reflected by the medium 201 to output the distance detection signal. It should be noted that the distance detection sensor 129 can be a device using an ultrasonic wave instead of the infrared light.

The printer side control section 165 includes a printer side CPU 166, a printer side ROM 167, and a printer side RAM 168.

The printer side CPU 166 develops a variety of control programs stored in the printer side ROM 167 in the printer side RAM 168, and then executes the variety of control programs to thereby perform a variety of types of control. It should be noted that it is possible for the printer side control section 165 to use a hardware circuit such as an ASIC (Application Specific Integrated Circuit) as a processor instead of the printer side CPU 166. Further, the processor can be provided with a configuration in which one or more CPUs and a hardware circuit such as an ASIC operate in cooperation with each other.

The printer side ROM 167 stores a variety of control programs and a variety of types of control data. The printer side RAM 168 is used as a work area for the printer side CPU 166 to perform a variety of types of control. Further, the printer side RAM 168 has a first job area 168a. The first job area 168a stores the print job transmitted from the information processing device 1. The first job area 168a is an example of a “storage section.”

The printer side CPU 166 detects the amounts of movement in the X direction and the Y direction of the printer 101 based on the movement detection signal output from the movement detection sensor 125. The printer side CPU 166 calculates movement distances in the X direction and the Y direction of the printer 101 from the amounts of the movement in the X direction and the Y direction detected, and then detects the movement direction of the printer 101 and at the same time controls the print head 121 based on the movement distances calculated. More specifically, the printer side CPU 166 ejects the ink from each of the nozzles of the print head 121 at the timing based on the movement distances thus calculated. Thus, it is possible for the printer 101 to appropriately print the print image 203 on the medium 201 regardless of the speed at which the user 301 moves the printer 101.

Further, when the printer 101 is moved in an opposite direction to the movement direction of the printer 101 in the pass in which the printing is in progress in the middle of the printing, the printer side CPU 166 stops the printing by the print head 121 in the pass in which the printing is in progress and the subsequent passes. Further, when the printer 101 is once separated from the medium 201 after stopping the printing, and is then loaded on the medium 201 once again, the printer side CPU 166 restarts the printing from the first pass. The printer side CPU 166 determines that the printer 101 is separated from the medium 201, and that the printer 101 is loaded on the medium 201 based on the distance detection signal output from the distance detection sensor 129.

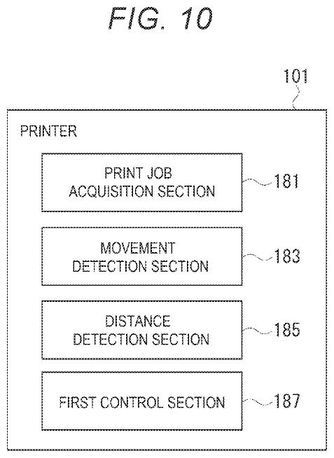

The functional configuration of the printer 101 will be described with reference to FIG. 10. The printer 101 is provided with a print job acquisition section 181, a movement detection section 183, a distance detection section 185, and a first control section 187. These functions are all realized by the printer side CPU 166 executing the control program stored in the printer side ROM 167. The first control section 187 is an example of a “control section.”

The print job acquisition section 181 obtains the print job for printing the print image 203 from the information processing device 1. The processing of the print job acquisition section 181 is an example of a “print job acquisition step.”

The movement detection section 183 detects the movement direction of the printer 101 relative to the medium 201 based on the movement detection signal output from the movement detection sensor 125. The processing of the movement detection section 183 is an example of a “movement detection step.”

The distance detection section 185 detects the distance of the printer 101 from the medium 201 based on the distance detection signal output from the distance detection sensor 129.

When the print job is obtained by the print job acquisition section 181, the first control section 187 stores the print job thus obtained in the first job area 168a. Further, when the print job including information representing the print type of “text” and the printing direction of “unidirectional printing” is obtained by the print job acquisition section 181, the first control section 187 makes the print head 121 perform printing while the printer 101 is moved in the +X direction in all of the passes. Further, when the print job including information representing the print type of “text” and the printing direction of “bidirectional printing,” and the print job including information representing the print type of “image” are obtained by the print job acquisition section 181, the first control section 187 makes the print head 121 perform printing while the printer 101 is moved in the +X direction in the odd-numbered passes, and makes the print head 121 perform printing while the printer 101 is moved in the −X direction in the even-numbered passes.

Further, when the printer 101 is moved in an opposite direction to the movement direction of the printer 101 in the pass in which the printing is in progress in the middle of the printing of the print image 203 regardless of the information representing the print type and the information representing the printing direction included in the print job, the first control section 187 performs a printing stop process of stopping the printing by the print head 121 in the pass in which the printing is in progress and the subsequent passes.

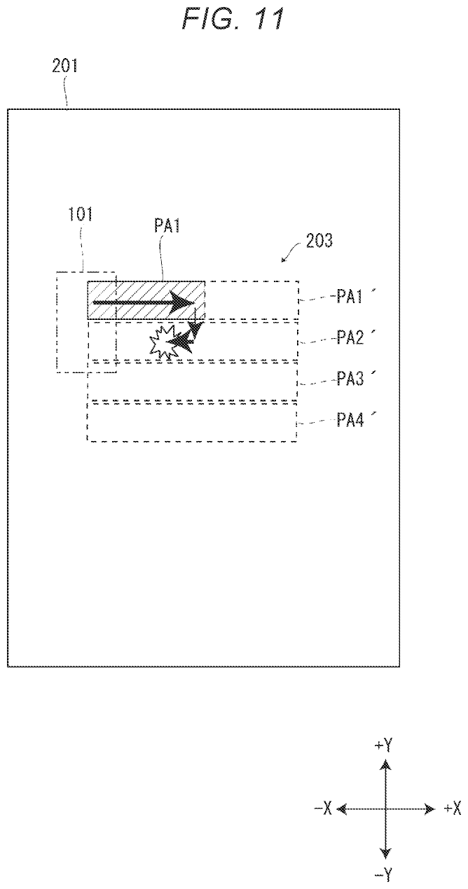

As shown in FIG. 11, when the printing of the print image 203 is performed in, for example, four passes, when the printer 101 performs printing of a print image PA1 in the first pass while being moved toward the +X direction, and is then moved toward the −Y direction in the middle of the printing of the print image PA1 in the first pass, and then moved toward the −X direction, the first control section 187 makes the printer 101 stop the printing in the rest of the first pass, and the printing in the second pass and the subsequent passes. Further, when the printer 101 is moved toward the −X direction without being moved toward the −Y direction in the middle of the printing of the print image PA1 in the first pass, the first control section 187 also makes the printer 101 stop the subsequent printing. As described above, the situation in which the printer 101 is moved in the opposite direction to the movement direction of the printer 101 in the first pass despite the fact that the printer 101 is in the middle of the printing of the print image PA1 in the first pass occurs when the user 301 is misled into thinking that the printing in the first pass is completed in the middle of the printing in the first pass, and so on. In this case, for example, when the printer 101 continues the printing in the second pass and the subsequent passes, the print image 203 is incompletely printed to thereby cause a waste in the ink and the medium 201. Therefore, when the printer 101 is moved toward the −X direction in the middle of the printing of the print image PA1 in the first pass, the first control section 187 stops the printing of the rest of the print image PA1′ in the first pass, a print image PA2′ to be printed in a second pass, a print image PA3′ to be printed in a third pass, and a print image PA4′ to be printed in a fourth pass as indicated by the dotted lines.

Further, the first control section 187 gives notice of the error as a part of the printing stop process. The first control section 187 blinks the LED incorporated in the print button 115 to thereby give notice of the error.

Further, the first control section 187 determines that the printer 101 has been separated from the medium 201 when a distance detected by the distance detection section 185 exceeds a first threshold value after performing the printing stop process, and determines that the printer 101 has been reloaded on the medium 201 when the distance changes from the state of exceeding the first threshold value to the state of being not higher than a second threshold value as a threshold value no higher than the first threshold value. The first threshold value and the second threshold value can be the same value. Further, the first control section 187 keeps the state in which the print job is stored in the first job area 168a even after performing the printing stop process, and when the first control section 187 receives a printing start instruction after determining that the printer 101 has been reloaded on the medium 201, the first control section 187 starts printing from the first pass based on the print job stored in the first job area 168a. The processing of the first control section 187 described hereinabove is an example of a “first control step.”

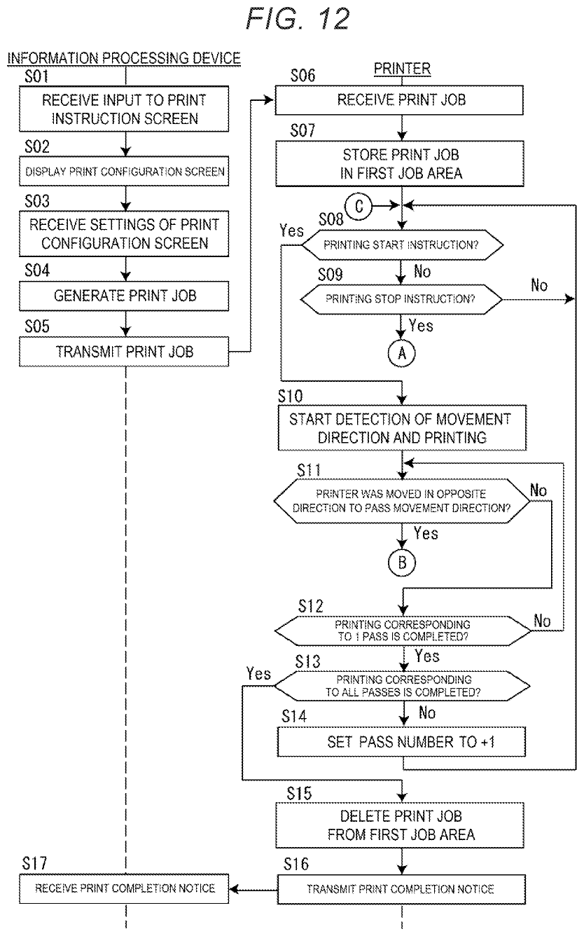

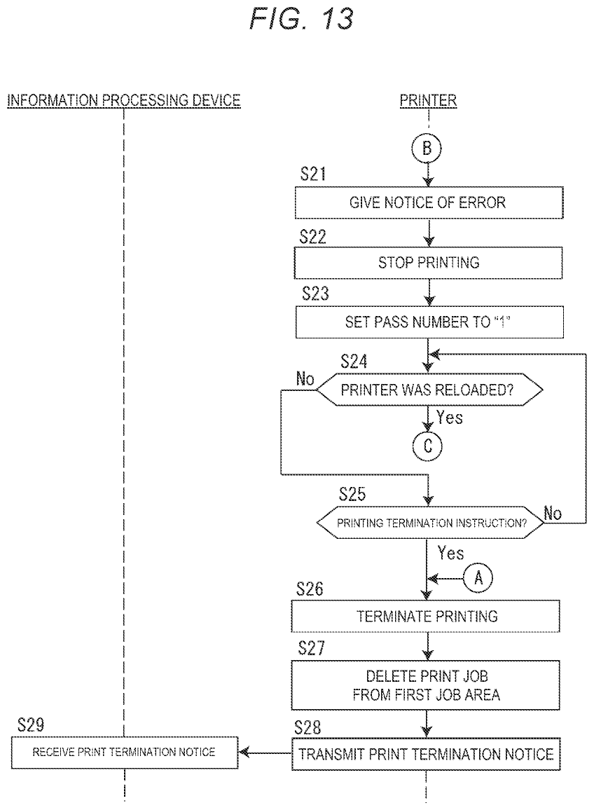

The flow of the processing of the printing system SY will be described with reference to FIG. 12 and FIG. 13. It is assumed that the information processing device 1 is in the state in which the dedicated application 17a is started up, and the print instruction screen 21 is displayed in the operation/display section 11.

In the step S01, the information processing device 1 receives input to the print instruction screen 21. In the print instruction screen 21, the information processing device 1 receives the selection of the print type, and the input of the information corresponding to the print type thus selected.

In the step S02, the information processing device displays the print configuration screen 31 in the operation/display section 11.

In the step S03, the information processing device 1 receives settings of the print configuration screen 31. In the print configuration screen 31, the information processing device 1 receives the selection of the printing direction.

In the step S04, the information processing device 1 generates the print job based on the information input to the print instruction screen 21 and the settings of the print configuration screen 31.

In the step S05, the information processing device 1 transmits the print job generated in the step S04 to the printer 101.

In the step S06, the printer 101 receives the print job transmitted from the information processing device 1.

In the step S07, the printer 101 stores the print job received in the step S06 in the first job area 168a.

In the step S08, the printer 101 determines whether or not the printing start instruction has been made. When the short press of the print button 115 is made, the printer 101 determines that the printing start instruction has been made. When the printer 101 determines that the printing start instruction has been made, the printer 101 proceeds to the step S10. Further, when the printer 101 determines that the printing start instruction has not been made, the printer 101 proceeds to the step S09.

In the step S09, the printer 101 determines whether or not the printing termination instruction has been made. When the long press of the print button 115 is made, the printer 101 determines that the printing termination instruction has been made. When the printer 101 determines that the printing termination instruction has been made, the printer 101 proceeds to the step S26 in FIG. 13. Further, when the printer 101 determines that the printing termination instruction has not been made, the printer 101 returns to the step S08.

In the step S10, the printer 10 starts the detection of the movement direction of the printer 101 and the printing. The printer 101 detects the movement direction of the printer 101 based on the movement detection signal output from the movement detection sensor 125. Further, the printer 101 performs drive control of a head driver not shown for driving the print head 121 to thereby perform the printing.

In the step S11, the printer 101 determines whether or not the printer 101 has been moved in an opposite direction to a pass movement direction as the movement direction of the printer 101 in the pass in which the printing is in progress. The pass movement direction is determined based on the information representing the printing direction included in the print job or the information representing the print type. For example, when the information representing the print type of “image” is included in the print job, the printer 101 determines that the pass movement direction is the +X direction when the pass in which the printing is in progress is the odd-numbered pass, and determines that the pass movement direction is the −X direction when the pass in which the printing is in progress is the even-numbered pass. When the printer 101 determines that the printer 101 has been moved in the opposite direction to the pass movement direction, the printer 101 proceeds to the step S21 in FIG. 13. Further, when the printer 101 determines that the printer 101 has not been moved in the opposite direction to the pass movement direction, namely the printer 101 has been moved in the pass movement direction, the printer 101 proceeds to the step S12.

In the step S12, the printer 101 determines whether or not the printing corresponding to one pass is completed. When the printer 101 determines that the printing corresponding to one pass has been completed, the printer 101 proceeds to the step S13. Further, when the printer 101 determines that the printing corresponding to one pass has not been completed, the printer 101 returns to the step S11.

In the step S13, the printer 101 determines whether or not the printing corresponding to all of the passes is completed. When the printer 101 determines that the printing corresponding to all of the passes has been completed, the printer 101 proceeds to the step S15. Further, when the printer 101 determines that the printing corresponding to all of the passes has not been completed, the printer 101 proceeds to the step S14.

In the step S14, the printer 101 sets the pass number of the pass in which the printing is subsequently performed to “(pass number of the pass in which the printing has just been completed)+1.” After executing the step S14, the printer 101 returns to the step S08.

In the step S15, the printer 101 deletes the print job from the first job area 168a.

In the step S16, the printer 101 transmits a print completion notice representing that the printing is completed to the information processing device 1.

In the step S17, the information processing device 1 receives the print completion notice transmitted from the printer 101.

In the step S21 in FIG. 13, the printer 101 gives notice of the error. The printer 101 blinks the LED incorporated in the print button 115 to thereby give notice of the error.

In the step S22, the printer 101 stops the printing. The printer 101 stops the drive of the head driver not shown to thereby stop the printing.

In the step S23, the printer 101 sets the pass number of the pass in which the printing is subsequently performed to “1.”

In the step S24, the printer 101 determines whether or not the printer 101 has been reloaded. When the printer 101 determines that the distance from the medium 201 is changed from the state of exceeding the first threshold value to the state of being no higher than the second threshold value as the threshold value no higher than the first threshold value based on the distance detection signal output from the distance detection sensor 129 after stopping the printing, the printer 101 determines that the printer 101 has been reloaded. When the printer 101 determines that the printer 101 has been reloaded, the printer 101 returns to the step S08 in FIG. 12. Further, when the printer 101 determines that the printer 101 has not been reloaded, the printer 101 proceeds to the step S25.

It should be noted that it is possible for the printer 101 to set the pass number to “1,” and then return to the step S08 in FIG. 12 after determining that the printer 101 has been reloaded instead of setting the pass number to “1” in the step S23.

In the step S25, the printer 101 determines whether or not the printing termination instruction has been made. When the long press of the print button 115 is made, the printer 101 determines that the printing termination instruction has been made. When the printer 101 determines that the printing termination instruction has been made, the printer 101 proceeds to the step S26. Further, when the printer 101 determines that the printing termination instruction has not been made, the printer 101 returns to the step S24.

In the step S26, the printer 101 terminates the printing. It should be noted that terminating the printing means forcibly terminating the printing based on the printing termination instruction by the user 301, and is different from completing the printing due to the completion of the printing in all of the passes.

In the step S27, the printer 101 deletes the print job from the first job area 168a.

In the step S28, the printer 101 transmits a print termination notice representing that the printing is terminated to the information processing device 1.

In the step S29, the information processing device 1 receives the print termination notice transmitted from the printer 101.

As described hereinabove, when the printer 101 according to the present embodiment determines that the printer 101 has been moved in the opposite direction to the movement direction of the printer 101 in the pass in which the printing is in progress in the middle of the printing of the print image 203, the printer 101 performs the printing stop process of stopping the printing in the pass in which the printing is in progress and the subsequent passes. Thus, it is possible for the printer 101 to prevent the print image 203 from being incompletely printed to cause a waste in the consumables related to printing such as the ink or the medium 201.

Further, the printer 101 notifies the user 301 of the error as a part of the printing stop process. Thus, it is possible for the user 301 to figure out that the printing is stopped.

Further, when the printer 101 determines that the printer 101 has been reloaded after performing the printing stop process, the printer 101 restarts the printing from the first pass. Thus, it is possible for the user 301 to restart the printing without performing an operation for making the printer 101 obtain the print job only by reloading the printer 101 on the medium 201 after the printing stop process.

It should be noted that in the first embodiment, the following modified examples can be adopted.

### MODIFIED EXAMPLE 1-1

Although the printer 101 according to the embodiment described above gives notice of the error by blinking the LED incorporated in the print button 115 when the printer 101 is moved in the opposite direction to the movement direction of the printer 101 in the pass in which the printing is in progress, it is possible to give notice of the error by lighting the print button 115. Further, it is possible for the printer 101 to light the LED incorporated in the print button 115 during the printing, and put the LED incorporated in the print button 115 off to thereby give notice of the error when it is determined that the printer 101 has been moved in the opposite direction to the movement direction of the printer 101 in the pass in which the printing is in progress.

Further, as a further modified example, it is possible for the printer 101 to give notice of the error using a sound or a vibration. In this case, a sound generation device and the vibration generation device are each an example of the “notification section.”

### MODIFIED EXAMPLE 1-2

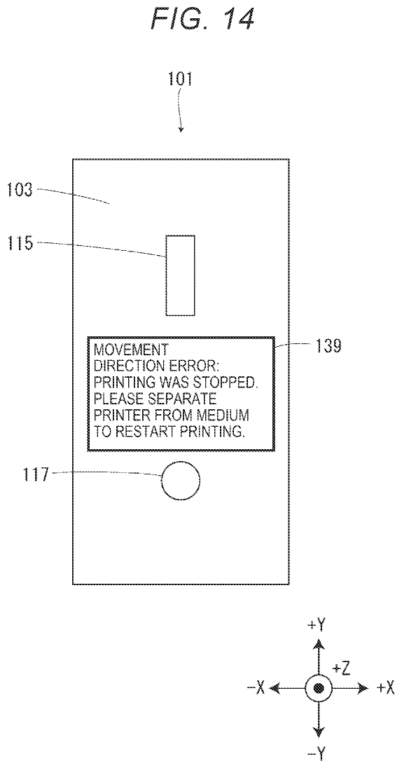

Further, as shown in FIG. 14, it is possible for the printer 101 to give notice of the error using a display 139. In this case, it is sufficient for the printer 101 to give notice of the error by making the display 139 display a message that the printing is stopped and a message for prompting to separate the printer 101 from the medium 201 and then restart the printing. In this case, the display 139 is an example of the “notification section.”

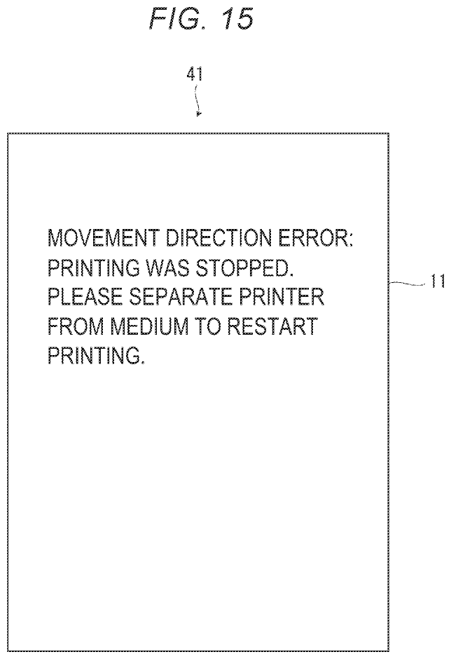

Further, as a further modified example, it is possible for the information processing device 1 to give notice of the error. In this case, it is sufficient for the printer 101 to transmit the error information to the information processing device 1 when the printer 101 determines that the printer 101 is moved in the opposite direction to the movement direction of the printer 101 in the pass in which the printing is in progress. Further, in response thereto, it is sufficient for the information processing device 1 to make the operation/display section 11 display an error screen 41 based on the error information received from the printer 101 as shown in FIG. 15. It is sufficient for the information processing device 1 to display the message that the printing by the printer 101 is stopped and the message for prompting to separate the printer 101 from the medium 201 and then restart the printing on the error screen 41. In this case, the operation/display section 11 of the information processing device 1 is an example of the “notification section.”

### MODIFIED EXAMPLE 1-3

Although in the printer 101 according to the embodiment described above, the bidirectional printing can only be selected as the printing direction and the unidirectional printing cannot be selected as the printing direction when the “image” is selected as the print type, it is possible to make it possible to select the unidirectional printing as the printing direction. Further, it is possible for the printer 101 to be provided with a configuration in which the printing is not stopped when it is determined that the printer 101 has been moved in the opposite direction to the movement direction of the printer 101 in the pass in which the printing is in progress when the unidirectional printing is selected regardless of whether the print type is “image” or “text.” Specifically, when the unidirectional printing is selected as the printing direction, the printer 101 temporarily aborts the printing when the printer 101 determines that the printer 101 has been moved in the opposite direction to the movement direction of the printer 101 in the pass in which the printing is in progress, but can resume the printing from the place where the printing in the pass in which the printing is in progress has been aborted when the printer 101 subsequently determines that the printer 101 has been moved in the movement direction of the printer 101 in the pass in which the printing is in progress.

### MODIFIED EXAMPLE 1-4

Although the printer 101 according to the embodiment described above restarts the printing from the first pass of the print job when the printer 101 is reloaded and then receives the printing start instruction, it is possible to restart the printing without receiving the printing start instruction. Specifically, it is possible for the printer 101 to retrieve the print job from the first job area 168a, and then restart the printing from the first pass based on the print job thus retrieved when the printer 101 determines that the printer 101 has been reloaded after the printing stop process.

Further, as a further modified example, it is possible for the printer 101 to be provided with a configuration in which the determination on whether or not the printer 101 has been reloaded is not performed. In this case, it is possible for the printer 101 to determine whether or not the printing start instruction has been received after the printing stop process, and then retrieve the print job from the first job area 168a to restart the printing from the first pass based on the print job thus retrieved when the printing start instruction receives.

### MODIFIED EXAMPLE 1-5

Although the printer 101 according to the embodiment described above obtains the print job from the information processing device 1, it is possible to obtain the print job from an external storage medium such as a flash memory. Alternatively, it is possible for the printer 101 to generate the print job by itself.

### MODIFIED EXAMPLE 1-6

It is possible to detect the movement direction of the printer 101 using not only the output signal from the movement detection sensor 125, but also an output signal from a gyro sensor for detecting the angular velocity of the printer 101.

### MODIFIED EXAMPLE 1-7

The print head 121 is not limited to the inkjet head, and can be, for example, a thermal head for performing printing using a thermal transfer system. In this case, it is possible for the print head 121 to be a device using other print materials than the ink such as an ink ribbon. Further, it is possible for the print head 121 to eject other liquids than the ink. For example, it is possible for the print head 121 to eject a liquid such as an adhesive or a coating agent.

Further, as a further modified example, it is possible for the print head 121 to be configured so as to detachably be attached to the printer 101 together with the ink cartridge containing the ink.

### MODIFIED EXAMPLE 1-8

Although the printer 101 according to the embodiment described above obtains the print job for performing the printing in a plurality of passes when printing the print image 203 in the plurality of passes, it is possible to obtain the print job pass by pass. In this case, it is sufficient for the printer 101 to request the print job in the next pass from the information processing device 1 when the printer 101 receives the printing start instruction, or completes the printing in the pass.

### Second Embodiment

Then, a second embodiment will be described. Although in the first embodiment, the printer 101 determines by itself whether or not the printer 101 has been moved in the opposite direction to the movement direction of the printer 101 in the pass in which the printing is in progress, this determination is performed at the information processing device 1 side in the second embodiment. Only the point in which the second embodiment is different from the first embodiment will hereinafter be described. It should be noted that in the present embodiment, substantially the same constituents as in the first embodiment are denoted by substantially the same reference numerals, and detailed descriptions thereof will be omitted. Further, the modified example applied to substantially the same constituents as in the first embodiment will be applied to the present embodiment in substantially the same manner.

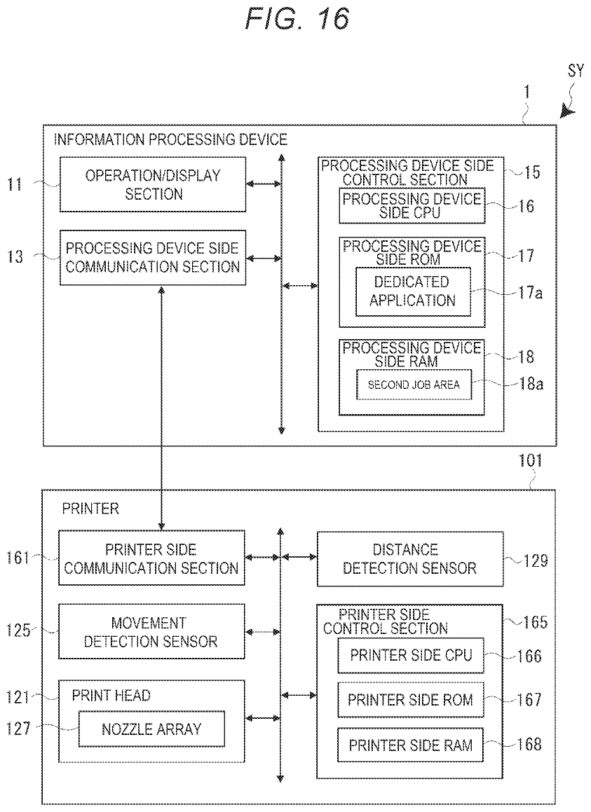

FIG. 16 is a control block diagram of a printing system SY according to the second embodiment. The printing system SY according to the second embodiment has a configuration in which the first job area 168a is eliminated from the printer side RAM 168 of the printer 101, and a second job area 18a is added to the processing device side RAM 18 of the information processing device 1 compared to the configuration (see FIG. 7) in the first embodiment. The second job area 18a stores the print job generated by the information processing device 1. Further, the dedicated application 17a stored in the processing device side ROM 17 in the present embodiment is an example of a “program.”

Further, when the short press of the print button 115 is made, the printer 101 according to the present embodiment starts the printing, and at the same time, transmits a printing start signal to the information processing device 1. Further, the printer 101 according to the present embodiment continues to transmit the movement detection signal output from the movement detection sensor 125 periodically to the information processing device 1 after the short press of the print button 115 is made until the printing is stopped, terminated, or completed. Further, when the long press of the print button 115 is made, the printer 101 according to the present embodiment finishes the printing, and at the same time, transmits a printing termination signal to the information processing device 1. Further, when the printer 101 according to the present embodiment determines that the printer 101 has been reloaded based on the detection result of the distance detection sensor 129, the printer 101 transmits a reload signal to the information processing device 1. Further, when the printer 101 according to the present embodiment receives a printing stop command from the information processing device 1, the printer 101 stops the printing.

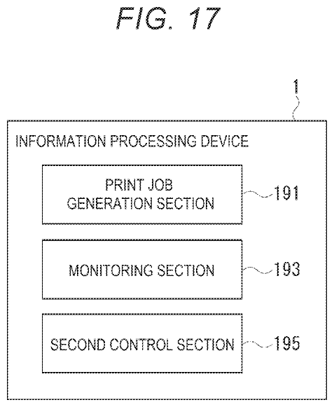

FIG. 17 is a functional block diagram of the information processing device 1 according to the second embodiment. The information processing device 1 is provided with a print job generation section 191, a monitoring section 193, and a second control section 195. These functions are all realized by the processing device side CPU 16 executing the dedicated application 17a stored in the processing device side ROM 17.

The print job generation section 191 generates the print job for making the printer 101 print the print image 203. The processing of the print job generation section 191 is an example of a “print job generation step.”

The monitoring section 193 periodically receives the movement detection signal from the printer 101 to thereby monitor the movement direction of the printer 101 relative to the medium 201. The processing of the monitoring section 193 is an example of a “monitoring step.”

When the print job including the information representing the print type of “text” and the printing direction of “unidirectional printing” is generated by the print job generation section 191, the second control section 195 makes the printer 101 perform printing while the printer 101 is moved in the +X direction in all of the passes. Further, when the print job including the information representing the print type of “text” and the printing direction of “bidirectional printing,” and the print job including the information representing the print type of “image” are generated by the print job generation section 191, the second control section 195 makes the printer 101 perform printing while the printer 101 is moved in the +X direction in the odd-numbered passes, and makes the printer 101 perform printing while the printer 101 is moved in the −X direction in the even-numbered passes. It should be noted that “making the printer 101 perform printing” means that the second control section 195 transmits the print job including the information representing the print type and the printing direction to the printer 101.

Further, when the second control section 195 determines that the printer 101 has been moved in the opposite direction to the movement direction of the printer 101 in the pass in which the printing is in progress in the middle of the printing of the print image 203 by the printer 101 based on the movement detection signal transmitted from the printer 101 regardless of the information representing the print type and the information representing the printing direction included in the print job, the second control section 195 makes the printer 101 stop the printing in the pass in which the printing is in progress and the subsequent passes.

Further, when the printer 101 is moved in the opposite direction to the movement direction of the printer 101 in the pass in which the printing is in progress in the middle of the printing of the print image 203 by the printer 101, the second control section 195 gives notice of the error. The second control section 195 makes the operation/display section 11 display the error screen 41 (see FIG. 15) to thereby give notice of the error.

Further, when the second control section 195 has received the reload signal from the printer 101 after stopping the printing, the second control section 195 makes the printer 101 restart the printing from the first pass based on the print job stored in the second job area 18a. Specifically, the second control section 195 stores the print job in the second job area 18a even after stopping the printing, and when the second control section 195 receives a printing start signal from the printer 101 after receiving the reload signal from the printer 101, the second control section 195 makes the printer 101 start the printing from the first pass based on the print job stored in the second job area 18a. It should be noted that the processing of the second control section 195 described hereinabove is an example of a “second control step.”

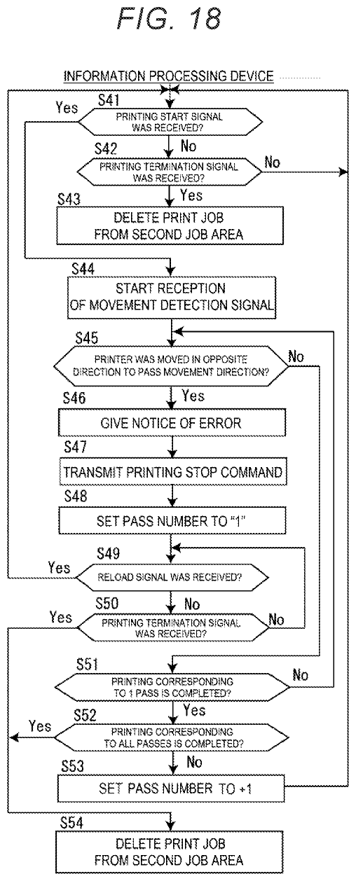

The flow of the processing of the information processing device 1 according to the second embodiment will be described with reference to FIG. 18. It is assumed that the information processing device 1 is in the state in which the dedicated application 17a is started up, and the step S01 through the step S05 shown in FIG. 12 have been executed. Further, it is assumed that the information processing device 1 has already generated the print job in the step S01, and then stored the print job thus generated in the second job area 18a in the processing device side RAM 18.

In the step S41, the information processing device 1 determines whether or not the printing start signal has been received from the printer 101. When the information processing device 1 determines that the printing start signal has been received, the information processing device 1 proceeds to the step S44. Further, when the information processing device 1 determines that the printing start signal has not been received, the information processing device 1 proceeds to the step S42.

In the step S42, the information processing device 1 determines whether or not the printing termination signal has been received from the printer 101. When the information processing device 1 determines that the printing termination signal has been received, the information processing device 1 proceeds to the step S43. Further, when the information processing device 1 determines that the printing termination signal has not been received, the information processing device 1 returns to the step S41.

In the step S43, the information processing device 1 deletes the print job from the second job area 18a.

In the step S44, the information processing device 1 starts to receive the movement detection signal from the printer 101.

In the step S45, the information processing device 1 determines whether or not the printer 101 has been moved in the opposite direction to the pass movement direction as the movement direction of the printer 101 in the pass in which the printing is in progress. When the information processing device 1 determines that the printer 101 has been moved in the opposite direction to the pass movement direction, the information processing device 1 proceeds to the step S46. Further, when the information processing device 1 determines that the printer 101 has not been moved in the opposite direction to the pass movement direction, the information processing device 1 proceeds to the step S50.

In the step S46, the information processing device 1 gives notice of the error. The information processing device 1 makes the operation/display section 11 display the error screen 41 (see FIG. 15) to thereby give notice of the error.

In the step S47, the information processing device 1 transmits the printing stop command to the printer 101.

In the step S48, the information processing device 1 sets the pass number of the pass in which the printing is subsequently performed to “1.”

In the step S49, the information processing device 1 determines whether or not the reload signal has been received from the printer 101. When the information processing device 1 determines that the reload signal has been received, the information processing device 1 returns to the step S41. Further, when the information processing device 1 determines that the reload signal has not been received, the information processing device 1 proceeds to the step S50.

In the step S50, the information processing device 1 determines whether or not the printing termination signal has been received from the printer 101. When the information processing device 1 determines that the printing termination signal has been received, the information processing device 1 proceeds to the step S54. Further, when the information processing device 1 determines that the printing termination signal has not been received, the information processing device 1 returns to the step S49.

In the step S51, the information processing device 1 determines whether or not the printing corresponding to one pass is completed. When the information processing device 1 determines that the printing corresponding to one pass has been completed, the information processing device 1 proceeds to the step S52. Further, when the information processing device 1 determines that the printing corresponding to one pass has not been completed, the information processing device 1 returns to the step S45.

In the step S52, the information processing device 1 determines whether or not the printing corresponding to all of the passes is completed. When the information processing device 1 determines that the printing corresponding to all of the passes has been completed, the information processing device 1 proceeds to the step S54. Further, when the information processing device 1 determines that the printing corresponding to all of the passes has not been completed, the information processing device 1 proceeds to the step S53.

In the step S53, the information processing device 1 sets the pass number of the pass in which the printing is subsequently performed to “(pass number of the pass in which the printing has just been completed)+1.” After executing the step S53, the information processing device 1 returns to the step S41.

In the step S54, the information processing device 1 deletes the print job from the second job area 18a.

As described hereinabove, when the printer 101 is moved in the opposite direction to the movement direction of the printer 101 in the pass in which the printing is in progress in the middle of the printing of the print image 203, the information processing device 1 in the second embodiment stops the printing in the pass in which the printing is in progress and the subsequent passes. Thus, it is possible for the information processing device 1 to prevent the print image 203 from being incompletely printed by the printer 101 to cause a waste in the consumables related to printing such as the ink or the medium 201.

It should be noted that in the second embodiment, the following modified example can be adopted.

### MODIFIED EXAMPLE 2-1

Although the information processing device 1 in the embodiment described above periodically receives the movement detection signal output from the movement detection sensor 125 from the printer 101, it is possible to receive information representing the movement direction of the printer 101 instead of the movement detection signal. In this case, it is sufficient for the printer 101 to detect the movement direction of the printer 101 based on the movement detection signal output from the movement detection sensor 125, and then transmit the information representing the movement direction thus detected to the information processing device 1.

### Additional Description

Hereinafter, the printer, the method of controlling the printer, and the non-transitory computer-readable storage medium storing a program will additionally be described.

The printer 101 is a printer 101 configured to perform printing on a medium while being manually moved to the medium, the printer 101 including the print job acquisition section 181 configured to obtain a print job for printing a print image in a plurality of passes, the movement detection section 183 configured to detect the movement direction of the printer 101 relative to the medium, and the first control section 187 configured to make the print head perform printing while the printer 101 is moved in the first direction in the odd-numbered pass, and make the print head perform printing while the printer 101 is moved in the opposite direction to the first direction in the even-numbered pass based on the print job, wherein when the printer 101 is moved in an opposite direction to the movement direction of the printer 101 in the pass in which the printing is in progress in the middle of the printing in the pass other than the last pass out of the plurality of passes, the first control section 187 performs the printing stop process of stopping the printing by the print head in the pass in which the printing is in progress and the subsequent passes.

The method of controlling the printer 101 is a method of controlling the printer 101 configured to perform printing on a medium while being manually moved to the medium, the method executing the print job acquisition step of obtaining the print job for printing the print image in the plurality of passes, the movement detection step of detecting the movement direction of the printer 101 relative to the medium, and the first control step of making the print head perform printing while the printer 101 is moved in the first direction in the odd-numbered pass, and making the print head perform printing while the printer 101 is moved in the opposite direction to the first direction in the even-numbered pass based on the print job obtained, wherein in the first control step, when the printer 101 is moved in the opposite direction to the movement direction of the printer 101 in the pass in which the printing is in progress in the middle of the printing in the pass other than the last pass out of the plurality of passes, the printing by the print head in the pass in which the printing is in progress and the subsequent passes is stopped.

According to this configuration, when the printer 101 is moved in the opposite direction to the movement direction of the printer 101 in the pass in which the printing is in progress in the middle of the printing in the pass other than the last pass out of the plurality of passes, the printer 101 stops the printing by the print head in the pass in which the printing is in progress and the subsequent passes. Thus, it is possible for the printer 101 to prevent the print image from being incompletely printed to cause a waste in the consumables related to printing.

In the printer 101 described above, the first control section 187 may give notice of an error as a part of the printing stop process.

According to this configuration, it is possible for the printer 101 to notify the user 301 of the error as a part of the printing stop process.

In the printer 101 described above, there may further be included the notification section.

According to this configuration, it is possible for the printer 101 to give notice of the error using the notification section provided to the printer 101.

In the printer 101 described above, there may further be included the storage section configured to store the print job, and the distance detection section 185 configured to detect a distance of the printer 101 from the medium, wherein when the distance detected by the distance detection section 185 changes from the state of exceeding the first threshold value to the state of being no higher than the second threshold value as a threshold value no higher than the first threshold value after performing the printing stop process, the first control section may make the print head restart printing from the first pass based on the print job stored in the storage section.

According to this configuration, it is possible for the printer 101 to make the print head restart the printing from the first pass when the distance from the medium changes from the state of exceeding the first threshold value to the state of being no higher than the second threshold value after performing the printing stop process. In other words, it is possible for the user 301 to restart the printing without performing an operation for making the printer 101 obtain the print job only by lifting the printer 101 to be separated from the medium and then reloading the printer 101 on the medium after the printing stop process is performed.

In the printer 101 described above, there may further be included the distance detection section 185 configured to detect a distance of the printer 101 from the medium, wherein the first control section 187 may determine that the printer 101 is separated from the medium when the distance detected by the distance detection section 185 exceeds the first threshold value, and may determine that the printer 101 is loaded on the medium when the distance detected by the distance detection section 185 becomes no higher than the second threshold value as a threshold value no higher than the first threshold value.

According to this configuration, it is possible for the printer 101 to determine that the printer 101 is separated from the medium when the distance from the medium exceeds the first threshold value, and determine that the printer 101 is loaded on the medium when the distance from the medium becomes no higher than the second threshold value.

In the non-transitory computer-readable storage medium storing a program, the program makes the information processing device 1 coupled to the printer 101 configured to perform printing on a medium while being manually moved to the medium so as to communicate with each other execute the print job generation step of generating the print job for making the printer 101 print a print image in a plurality of passes, the monitoring step of monitoring the movement direction of the printer 101 relative to the medium, and the second control step of making the printer 101 perform printing while the printer 101 is moved in the first direction in an odd-numbered pass, and making the printer 101 perform printing while the printer 101 is moved in the opposite direction to the first direction in an even-numbered pass based on the print job, wherein in the second control step, when the printer 101 is moved in the opposite direction to the movement direction of the printer 101 in the pass in which the printing is in progress in the middle of the printing in the pass other than the last pass out of the plurality of passes, the printing by the printer 101 in the pass in which the printing is in progress and the subsequent passes is stopped.

According to this configuration, when the printer 101 is moved in the opposite direction to the movement direction of the printer 101 in the pass in which the printing is in progress in the middle of the printing in the pass other than the last pass out of the plurality of passes, the information processing device 1 stops the printing in the pass in which the printing is in progress and the subsequent passes. Thus, it is possible for the information processing device to prevent the print image from being incompletely printed by the printer 101 to cause a waste in the consumables related to printing.

What is claimed is:

1. A printer configured to perform printing on a medium while being manually moved to the medium, the printer comprising:
a print job acquisition section configured to obtain a print job for printing a print image in a plurality of passes;
a movement detection section configured to detect a movement direction of the printer relative to the medium; and
a control section configured to make a print head perform printing while the printer is moved in a first direction in an odd-numbered pass, and make the print head perform printing while the printer is moved in an opposite direction to the first direction in an even-numbered pass based on the print job, wherein
when the printer is moved in an opposite direction to the movement direction of the printer in a pass in which the printing is in progress in a middle of the printing in the pass other than a last pass out of the plurality of passes, the control section performs a printing stop process of stopping the printing by the print head in the pass in which the printing is in progress and subsequent passes.

2. The printer according to claim 1, wherein
the control section makes a notification section give notice of an error as a part of the printing stop process.

3. The printer according to claim 2, further comprising:
the notification section.

4. The printer according to claim 1, further comprising:
a storage section configured to store the print job; and
a distance detection section configured to detect a distance of the printer from the medium, wherein
when the distance detected by the distance detection section changes from a state of exceeding a first threshold value to a state of being no higher than a second threshold value as a threshold value no higher than the first threshold value after performing the printing stop process, the control section makes the print head restart the printing from a first pass based on the print job stored in the storage section.

5. The printer according to claim 1, further comprising:
a distance detection section configured to detect a distance of the printer from the medium, wherein
the control section determines that the printer is separated from the medium when the distance detected by the distance detection section exceeds a first threshold value, and determines that the printer is loaded on the medium when the distance detected by the distance detection section becomes no higher than a second threshold value as a threshold value no higher than the first threshold value.

6. A method of controlling a printer configured to perform printing on a medium while being manually moved to the medium, the method comprising:
a print job acquisition step of obtaining a print job for printing a print image in a plurality of passes;
a movement detection step of detecting a movement direction of the printer relative to the medium; and
a first control step of making a print head perform printing while the printer is moved in a first direction in an odd-numbered pass, and making the print head perform printing while the printer is moved in an opposite direction to the first direction in an even-numbered pass based on the print job obtained, wherein
in the first control step, when the printer is moved in an opposite direction to the movement direction of the printer in a pass in which the printing is in progress in a middle of the printing in the pass other than a last pass out of the plurality of passes, the printing by the print head in the pass in which the printing is in progress and subsequent passes is stopped.

7. A non-transitory computer-readable storage medium storing a program, the program making an information processing device coupled to a printer configured to perform printing on a medium while being manually moved to the medium so as to communicate with each other execute processing comprising:
a print job generation step of generating a print job for making the printer print a print image in a plurality of passes;
a monitoring step of monitoring a movement direction of the printer relative to the medium; and
a second control step of making the printer perform printing while the printer is moved in a first direction in an odd-numbered pass, and making the printer perform printing while the printer is moved in an opposite direction to the first direction in an even-numbered pass based on the print job, wherein
in the second control step, when the printer is moved in an opposite direction to the movement direction of the printer in a pass in which the printing is in progress in a middle of the printing in the pass other than a last pass out of the plurality of passes, the printing by the printer in the pass in which the printing is in progress and subsequent passes is stopped.
